(19) United States
(12) Patent Application Publication
(10) Pub. No.: US 2008/0031674 A1
(43) Pub. Date: Feb. 7, 2008

(54) Automatic Loading/Unloading Device for Printing Supports in a Printer

(75) Inventor: Ivana Piana, Genova (IT)

Correspondence Address: RICHARD M. GOLDBERG, 25 EAST SALEM STREET, SUITE 419, HACKENSACK, NJ, 07601, US

(73) Assignee: GRAFOPLAST S.P.A., Predosa (AL) (IT)

(21) Appl. No.: 11/781,477

(22) Filed: Jul. 23, 2007

(30) Foreign Application Priority Data
Aug. 3, 2006 (IT) GE2006A000081

(51) Int. Cl. B41J 13/24

(52) U.S. Cl. 400/622

(57) ABSTRACT

Automatic loading/unloading device for printing supports in a printer including a track (2) able to slide on a suitable resting plane of the printer by way of a thrust arrangement, a board or blade (3) able to receive a printing support, substantially of rectangular shape, positioned in correspondence with an opening (21) substantially rectangular, created on the track, where the blade (3) has a portion of its edge (31) able to be bonded in an articulated way to a portion of the rim (221) of the opening (21) of the track and where the blade (3) has guides (34) able to allow a stable attachment between the board and the rear systems of attachment of the printing supports.

The subject of this invention is an automatic loading/unloading device for printing supports, including for instance identification tags (terminal block tags, tubes and wire markers), in a printer.

Such tags are an identification system for electronic components (cables, plant, tools, control panels, etc.) on which are stamped identification or references by means of a suitable printer. Such identification systems, if compared to the identification carried out by means of the manual composition of pre-identification elements, allow one to perform the operation of markings with rapidity and precision, even for large series of markings.

The tags are generally formed starting from a rigid plate made up of various comb-like components derived for instance from injection moulding of thermoplastic material. Said comb-like components may be separated from one another by means of passing cut lines, which separate various teeth and by means of non-passing pre-fracture lines, useful to facilitate reciprocal detachment of the comb-like sets and detachment of the comb-like sets from the individual identification tags.

These identification tags are arranged on special supports, they are detached from their comb-like element and are mounted on the elements to be marked or they are directly detached and mounted on elements already fitted with a support.

The marking of these tags is advantageously obtained by means of printers in which the tags are fed through a loading/unloading device made up of a track on which is placed the plate containing the tags in a pre-arranged position. Said track moves suitably bringing the plate into the pre-arranged position in correspondence with the print head of the printer.

Once the tags have been suitably marked, the track continues on its run allowing the plate to be removed, for instance manually.

In the SI2 KPRINT1 printer marketed by GRAFOPLAST the loading/unloading device has a track on which a housing has been created for a plate containing the tags. The housing is made up of a rectangular board, positioned in correspondence with an opening that is likewise rectangular created on the track and fixed on one side to the corresponding edge of said opening by means of an adhesive. In this way the board can oscillate and in particular rotate downwards when the track is not resting on a support. This device functions in the following way. Initially the plate containing the tags is positioned on the board and the track is resting on the support of the printer in such way that the board cannot rotate downwards, substantially keeping the plate on the same plane as the track.

Then the track is moved by way of suitable means bringing the plate under the print head of the printer. Once the tags have been printed the track continues with its movement until it reaches the discharge position of the plate with the tags. This takes place when the portion of the track that contains the board comes out of the lower support on which it runs and due to gravity allows the board itself to rotate downwards discharging the plate which carries the tags.

Even though valid this system has some inconveniences. First and foremost, the board bearing the plate has a flat surface, lacking attachment guides, therefore it is not possible to print plates with clamping tags fitted with attachment pins in their lower part automatically. Furthermore, the adhesive between the edge of the track and the board may be an unsafe constraint in that it may deteriorate over time causing jamming or printing defects.

The aim of this invention is that of remedying the aforesaid inconveniences by creating a loading/unloading device for printing supports in a printer in which the printing support is positioned on the track by means of an automatic feeder and discharge of the printed support is performed automatically.

This invention sets out to create an automatic feeding device according to claim 1 to which one is referred for brevity.

Other features and advantages of such a device according to this invention will be more clearly evident from the following description, exemplifying and not limitative, referring to the schematic drawings attached in which:

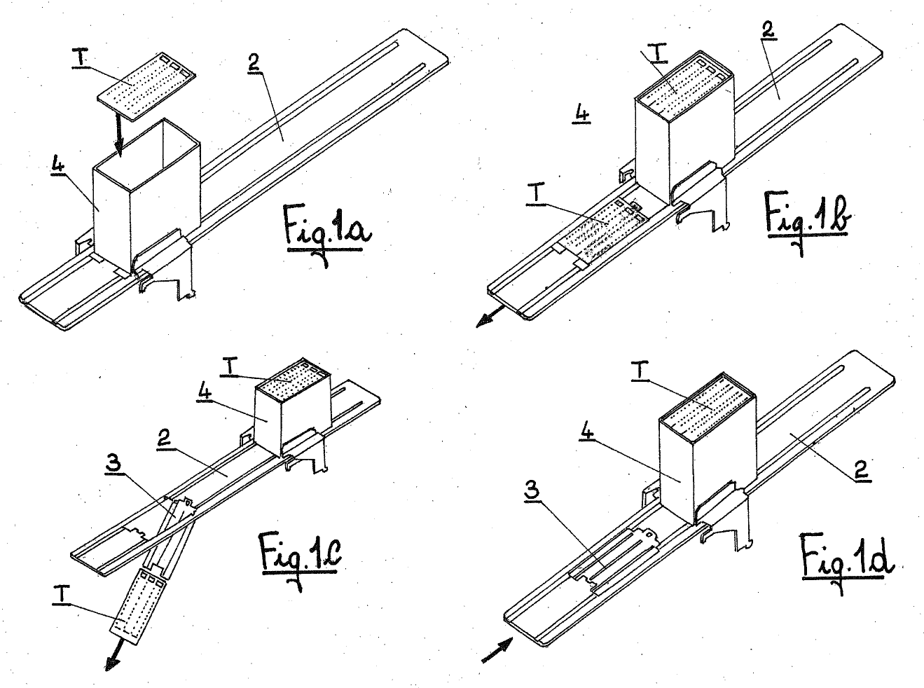

FIG. 1a illustrates the automatic loading/unloading device in the loading phase according to this invention;

FIG. 1b illustrates the automatic loading/unloading device in the printing phase according to this invention;

FIG. 1c illustrates the automatic loading/unloading device in the unloading phase according to this invention;

FIG. 1d illustrates the automatic loading/unloading device in the phase of returning to the loading position according to this invention;

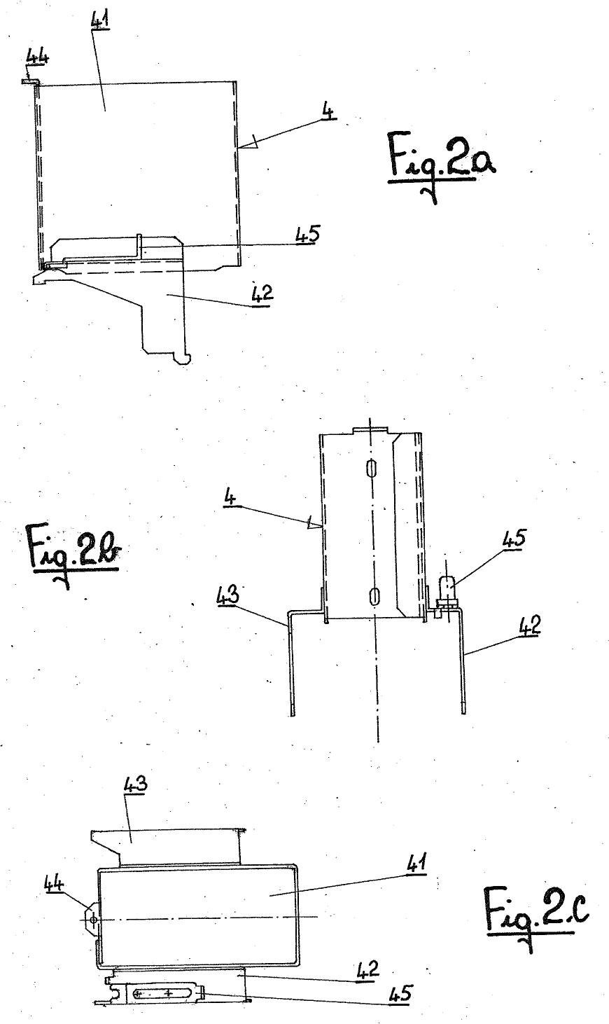

FIGS. 2a, 2b and 2c illustrate the feeder of the automatic loading/unloading device according to this invention;

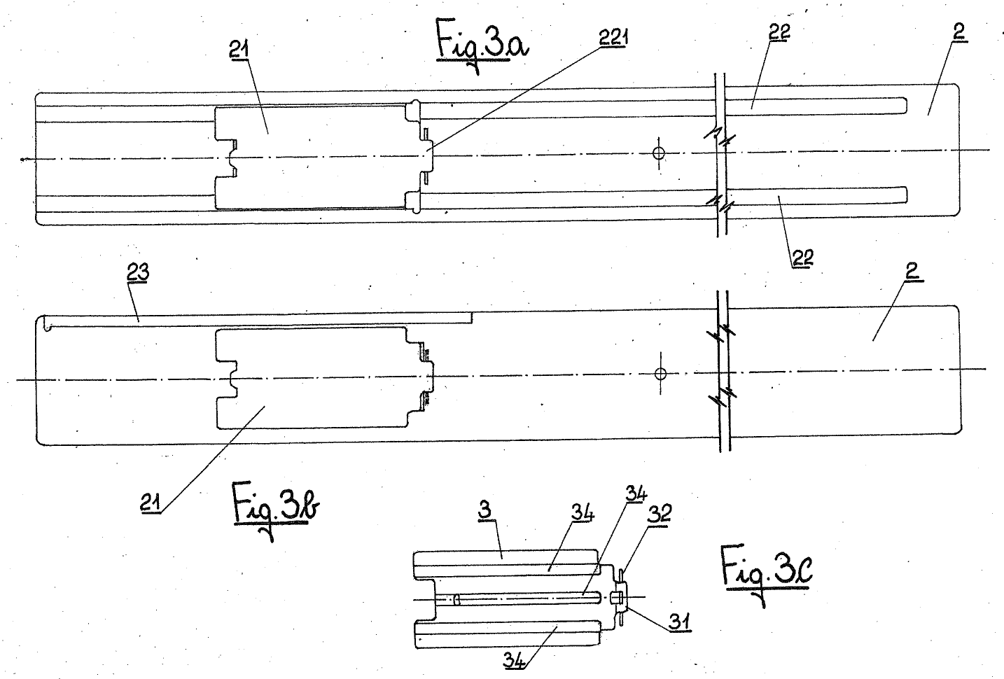

FIG. 3a illustrates the track of the automatic loading/unloading device seen from above according to this invention;

FIG. 3b illustrates the track of the automatic loading/unloading device seen from below according to this invention;

FIG. 3c illustrates the board of the automatic loading/unloading device seen from above according to this invention;

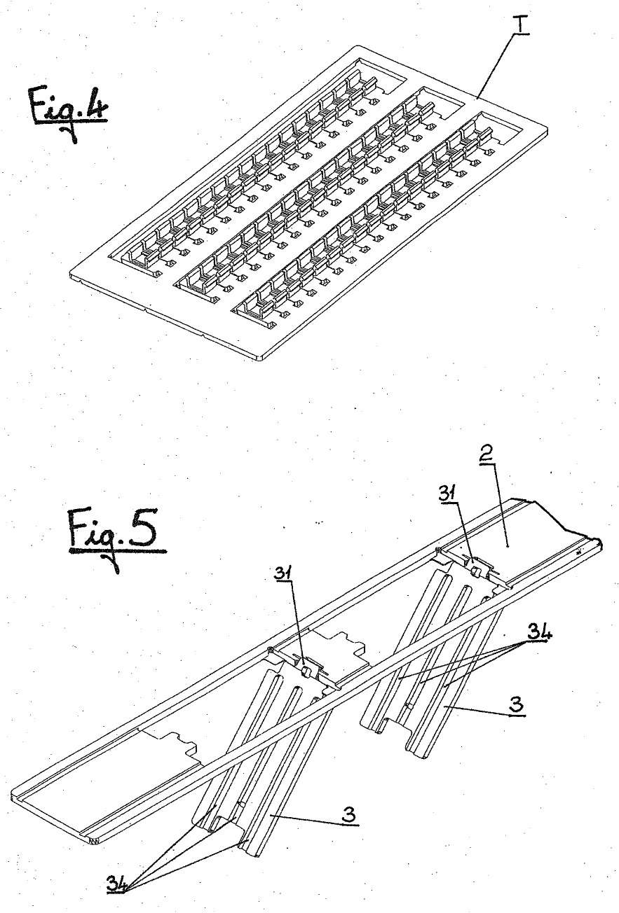

FIG. 4 exemplarily illustrates a well known plate used in this field bearing tags with pins;

FIG. 5 illustrates in a perspective view the track of the automatic loading/unloading device fitted with a number of boards arranged to receive the printing supports.

With reference to the above mentioned figures the automatic loading/unloading device for printing supports includes a track 2 which is able to move, on a suitable resting plane (not shown) of the printer by way of means of thrust, for instance created through rollers, a board or blade 3, there to receive such a printing support, substantially of rectangular shape, positioned in correspondence with an opening 21 substantially rectangular created on said track. A portion of the edge 31 of this blade is arranged to be fixed in an articulated way to a corresponding portion of the rim 221 of the opening 21 of said track. The articulated bond is obtained through a rigid system, for instance by means of a hinge 32 which allows rotation of at least 90° of the blade.

The dimensions of the blade may vary according to the type of printing support, for instance the tags that must be housed within it. The positioning of the blade is such as to determine a step between it and the edge of the opening 21 of the track, thereby creating a seat in which the printing support, in the case illustrated the plate T with the tags, remains imprisoned without the possibility of being further moved in the printing phase. Moreover, on this track there is also a pair of guides 22 usable to correctly position a feeder 4 of the plates on the board 3. The latter also has guides 34 aimed at allowing a stable attachment between the board and the well known tags fitted with rear attachment systems such as, for instance, pins, as illustrated in FIG. 4. Furthermore, on one of the lateral sides this track has a housing 23 for an optic ruler that can be read by a sensor of the printer in order to monitor the position of the track and of the relative board along its path.

This feeder is made up of a body that is substantially a box, inside which there is a seating 41 for the housing of the plates bearing the tags to be printed piled one above the other and there to release one of the plates during the movement of the track, when this is above the board.

Furthermore, this feeder includes a pair of feet 42 and 43 there to fit the feeder onto the track 2 and not to interfere with the sliding of the track itself below the feeder. Moreover, it includes a guillotine for regulation 44 and a blocking bracket 45.

The automatic loading and unloading device according to this invention operates in the following way, making reference to the positions illustrated in FIGS. 1a, 1b, 1c and 1d.

In the position in FIG. 1a the plates bearing the tags to be printed are inserted in the seat of the feeder and the board of the track is positioned under the feeder, in such way that a plate may be positioned in the seat created on the board.

Once the plate is positioned on the blade or board, the track is moved in the direction of the arrow in FIG. 1b until the printing operations of the tags are terminated. Then, (FIG. 1c) when in its movement the track brings the board beyond the lower resting plane of the track itself, due to gravity it slopes and allows the plate to come out and to be discharged. Once this operation is terminated the track is moved back (in the direction of the arrow in FIG. 1d) and the lower support to the track determines the horizontal repositioning of the board aligned with the track.

According to a further feature of this invention illustrated exemplarily in FIG. 5, the software of the printer could be adjusted to guarantee the automatism of the loading operations for printing and discharge of the plates by creating a track having a plurality of openings and a plurality of boards bonded in an articulated way to the track. In such way one could print on different plates during the same passing (i.e. the movement in advancing of the track below the printing head of the press).

From the description carried out the features of the automatic loading/unloading device for printing supports subject of this invention appear clear, just as the advantages appear clear.

In particular, they are represented by:
an increase of printing speed (number of tags printed) in that the process is completely automatic;
elimination of the printing imperfections due to imprecise positioning of the printing support, i.e. the plate;
reliability of the device over time in that the elimination of the adhesive replaced by the hinged system determines the strengthening and substantial inalterability in time of the structure;
possibility of a rapid interchangeability of the boards in order to allow the printing of different types of tag with different shapes of attachment pins.

Finally, it is clear that numerous variations may be made to this invention, without for this leaving the principles of novelty implicit in the inventive idea, just as it is clear that, in the practical implementation of the invention, the materials, shapes and sizes of the details illustrated may be whatsoever according to the needs and the same may be substituted with others that are technically equivalent.

What is claimed is:

1. Automatic loading/unloading device for printing supports in a printer comprising:
a track able to run along a suitable resting plane of the printer by way of thrusting arrangement, the track having a substantially rectangular opening with a rim,
a board, able to receive a printing support, the board being of a substantially rectangular shape and having an edge and said board positioned in correspondence with the substantially rectangular opening created in said track, and
a portion of the edge of said board being adapted to be linked in an articulated way to a corresponding portion of the rim of the opening of said track.

2. Device according to claim 1, in which the articulated link is obtained by a hinge that allows a rotation of at least 90° of the board relative to the track.

3. Device according to claim 1, in which the positioning of the board on the track is such that there is a step between the board and the rim of the opening of the track, thereby creating a housing in the board in which the printing support remains imprisoned without the possibility of being moved again in the printing phase.

4. Device according to claim 1, wherein the board has guides which permit a stable attachment between the board and posterior attachment systems of the printing supports.

5. Device according to claim 1, further including a feeder of said printing supports made up of a substantially box-like body, inside of which there is a seat for housing the printing supports piled one on the other and adapted to release said supports one at a time when, during the movement of the track, a lowermost support is above the board.

6. Device according to claim 1, in which the track has a pair of guides adapted to correctly position the feeder of the printing supports on the board.

7. Device according to claim 3, in which said feeder includes a pair of feet adapted to fit the feeder onto the track and not to interfere with sliding of the track itself below the feeder.

8. Device according to claim 3, in which said feeder includes a guillotine of regulation and a blocking bracket.

9. Device according to claim 1, in which said track includes a plurality of openings and a plurality of boards that are hinged in an articulated way, so as to print on more than one plate during the same advancing movement of the track under printing head of a printing press.
